(19) United States
(12) Patent Application Publication
(10) Pub. No.: US 2011/0019498 A1
(43) Pub. Date: Jan. 27, 2011

(54) Mixing Head For Reaction Injection Molded Materials

(76) Inventor: Otto A. Huiber, Kentwood, MI (US)

Correspondence Address: PRICE HENEVELD COOPER DEWITT & LITTON, LLP, 695 KENMOOR, S.E., P O BOX 2567, GRAND RAPIDS, MI, 49501, US

(21) Appl. No.: 12/839,510

(22) Filed: Jul. 20, 2010

Related U.S. Application Data
(60) Provisional application No. 61/227,169, filed on Jul. 21, 2009.

(51) Int. Cl. G05D 11/02; B01F 15/06

(52) U.S. Cl. 366/148; 366/152.2

(57) ABSTRACT

A mixing head assembly includes a mix head with ejection piston, and multiple hydraulic (or pneumatic) control valve assemblies (up to eight) each with a double-needle subassembly for feeding controlled amounts of material to the mixing chamber of the mix head in predetermined ratios and controlled quantities and at high pressures. The double-needle subassembly accurately and independently controls material flow within the control valve assembly and operates independently from other valve assemblies, thus permitting timed opening for optimal mixing during initiation, continuous mixing, and termination phases. The ejection piston is modified to eliminate longitudinal grooves for recirculating materials. The mixing head assembly is a closed loop system for controlled high pressure impingement mixing of multiple components and includes material recirculation. The present assembly permits accurate mixing (during initial and continuous flow) of multiple components, and allows changing mix materials on the fly, including during injections or between injections

This application claims benefit under 35 U.S.C. §119(e) of provisional application Ser. No. 61/227,169, filed Jul. 21, 2009, entitled MIXING HEAD FOR REACTION INJECTION MOLDING OF MATERIALS, the entire contents of which are incorporated herein by reference.

### BACKGROUND

The present invention relates to mixing heads for reaction injection molding systems adapted to mix materials in predetermined ratios and inject them into a mold.

Mixing heads are used to mix together flowable reaction components and then inject the reacting mixture into a mold. For example, see Boden U.S. Pat. No. 4,378,335 and Soechtig U.S. Pat. No. 4,966,466 which disclose mixing heads with control/ejection pistons. One type piston used in these mixing heads has longitudinally extending grooves (see grooves 13, 14 in Boden, and grooves 4 in Soechtig) that are moved between a recirculating position where unmixed components A and B are continuously recirculated but kept apart, and an injection-molding position where components are mixed and then immediately injected into a mold cavity. A problem is that the longitudinally extending grooves add complexity and inconsistency to operation of the mixing head. For example, the grooves can become plugged over time, obstructing material flow and causing machine downtime for maintenance. Even before plugging, a restriction in the grooves can adversely affect the mixing ratio of materials A:B. Cross-over of materials A and B from groove to groove is a problem, especially at the high pressures (e.g., 2000-3000 psi) and at high flow rates (e.g., several feet per second) that are often used. Further, the grooves can become worn, aggravating cross-over and material contamination. Further, the grooves add to difficulties in providing uniform and balanced start-up pressures and flows, throwing off initial mixing ratios until stability of flow is established. This is especially problematic when mixing ratios call for a high ratio, such as 10:1 of material A:B. In addition, changing mixing heads can be difficult, especially where one or both of the materials are reactive and not appropriate for contact with humans. Historically, mixing heads have to be changed every time there is a change in the type or ratio of materials being processed to avoid contamination of material and to change/deal with other process variables.

In particular, known mixing heads are inflexible. For example, known mixing heads do not allow for quick changeovers between different jobs where different ratios or different materials are required. Instead, the machines must be shut down while a new (clean) mixing head (or recalibrated mixing head) is put in place. Also, increased flexibility is desired in the ability of a mixing head to process a wider range of components and ratios without substantial modification to the mixing head and without substantial shutdown time.

### SUMMARY OF THE PRESENT INVENTION

In one aspect of the present invention, a mixing head assembly includes a main mix head with a control and ejection piston assembly, and at least two control valve assemblies. Each valve assembly includes a controlled needle subassembly having at least one needle valve for controlled feeding of different materials to a mixing chamber of the mix head in predetermined ratios and controlled quantities and at high pressures. The ejection piston assembly has a cylindrical surface with no longitudinal channels or grooves for conveying the different materials, the cylindrical surface closely engaging a mating surface on the main mix head.

In another aspect of the present invention, a mixing head assembly includes a main mix head with a control and ejection piston assembly, and at least two control valve assemblies, each with a controlled needle subassembly having a needle valve at each end for controlled feeding of different materials to a mixing chamber of the mix head in predetermined ratios and controlled quantities and at high pressures.

In another aspect of the present invention, a mixing head assembly includes a main mix head with a control and ejection piston assembly, and at least three control valve assemblies each with a controlled needle subassembly for controlled feeding of different materials to a mixing chamber of the mix head in predetermined ratios and controlled quantities and at high pressures.

In another aspect of the present invention, a method of mixing materials comprises steps of providing a main mix head with a control and ejection piston assembly, and providing at least two control valve assemblies each with a controlled needle subassembly having a needle valve immediately adjacent the main mix head, the ejection piston assembly having a cylindrical surface with no longitudinal channels or grooves, the cylindrical surface closely engaging a mating surface on the main mix head. The method further includes simultaneously controlling the feeding of different materials to a mixing chamber of the mix head in predetermined ratios and controlled quantities and at high pressures.

In another aspect of the present invention, a method of mixing materials comprises steps of providing a main mix head with a control and ejection piston assembly, and providing at least two control valve assemblies each with a controlled needle subassembly having a needle valve at each end. The method further includes simultaneously controlling the needle valve at each end for controlled feeding of different materials to a mixing chamber of the mix head in predetermined ratios and controlled quantities and at high pressures.

In another aspect of the present invention, a method of mixing materials comprises steps of providing a main mix head with a control and ejection piston assembly, and providing at least three control valve assemblies each with a controlled needle subassembly. The method further includes simultaneously operating the at least three valve assemblies to control feeding of different materials to a mixing chamber of the mix head in predetermined ratios and controlled quantities and at high pressures.

These and other aspects, objects, and features of the present invention will be understood and appreciated by those skilled in the art upon studying the following specification, claims, and appended drawings.

### BRIEF DESCRIPTION OF DRAWINGS

FIG. 1 is a side view of a mixing head assembly embodying the present invention, including a main mixing head with an ejection piston assembly (connected to a “cleanout plunger”) (extending vertically from the page), and multiple (two shown) opposing preassembled valve assemblies attached to the mixing head for feeding material to the main mixing head at predetermined rates and ratios.

FIG. 2 is a cross section taken longitudinally through FIG. 1.

FIG. 3 is an enlarged cross section of one of the preassembled valve assemblies in FIG. 1, the cleanout plunger closing the mix chamber and closing the passageway access to the mold cavity, and the preassembled valve assembly being in a closed recirculation position.

FIG. 4 is a cross section similar to FIG. 3 with the control needle subassembly still in a closed recirculation position but with the cleanout plunger pulled opening the passageway access to the mold cavity, FIG. 4A being similar but being shaded to show pressurized material and material flow during recirculation.

FIG. 5 is a cross section similar to FIG. 3 but with the control needle subassembly in an open injecting position (and the cleanout plunger also open), FIG. 5A being similar but being shaded to show pressurized material and material flow as the material is injected.

FIG. 6 is a cross section similar to FIG. 4, but showing a heating system for heating an area around the control needle subassembly, FIG. 6A being an identical view but with shaded areas showing flow of heated material around the control needle subassembly.

FIG. 7 is a perspective view of a modified mixing head assembly that provides a function similar to the assembly of FIG. 1.

FIGS. 8-10 are cross sectional (perspective) views taken through FIG. 7 along orthogonal planes.

FIG. 11 is a side view of FIG. 7 (with an orientation similar to FIG. 2).

FIG. 12 is a cross sectional view along line XII-XII in FIG. 11.

FIG. 13 is a partially exploded view of one control needle subassembly in FIG. 12.

FIG. 14 is a fragmentary view of half of FIG. 12, with components in their material-recirculation positions.

FIG. 15 is a fragmentary view similar to FIG. 14, but with components in their material-injection positions.

FIG. 16 is a view similar to FIG. 14 but showing components in flowing to a relief valve to eliminate overpressures and/or pressure spikes.

### DETAILED DESCRIPTION OF PREFERRED EMBODIMENTS

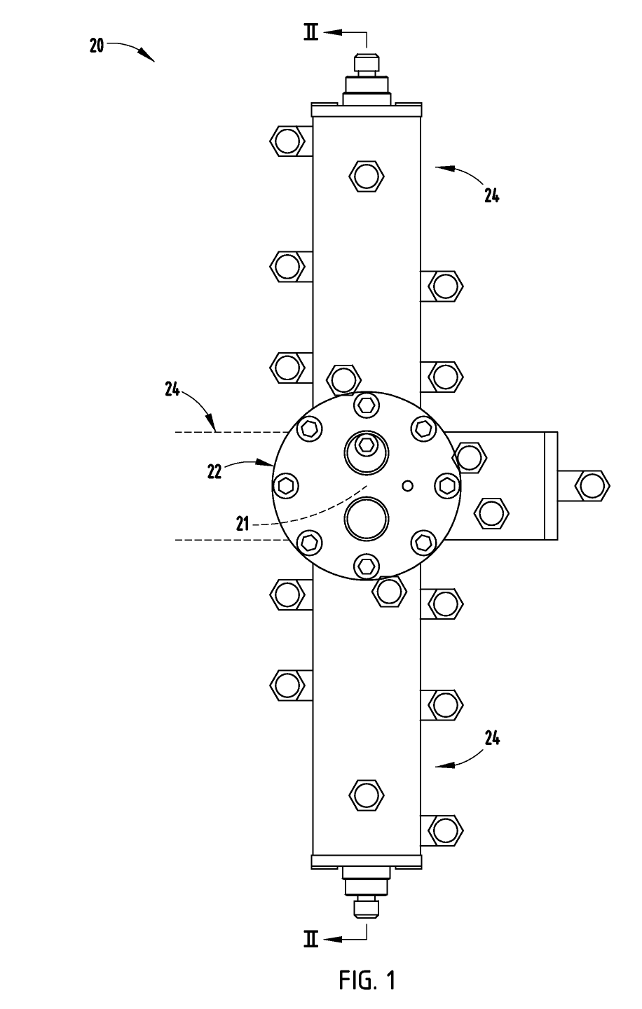

The present mixing head assembly 20 (FIG. 1) has a main mix head 21 with a hydraulic (or pneumatic) control 22 and an ejection piston 23 (also called a “clean-out plunger”) and multiple hydraulic control valve assemblies 24 (two shown, but could include up to seven or more) each with a needle subassembly 25 for feeding controlled amounts of material to the mixing chamber of the mix head 21 in predetermined ratios and controlled quantities and at high pressures. The illustrated mixing head assembly 20 is a closed loop system for controlled-ratio high pressure impingement mixing of multiple components (such as components A:B, or A:B:C), and with recirculation of components during non-injection phases of the device. For example, component A could be a polyol, and component B could be a reactive isocyanate material. Also, similar components could be mixed with a third component C such as fire retardant or colorant. Also, it is contemplated that component A could be mixed with a first-color component B and then switched (on-the-fly and without stopping the machine) to mix with a second-color component C, or a third, or a fourth, or a fifth, etc. Notably, the component ratios can be changed to accommodate the change. It is contemplated that the present apparatus can be used to mix and inject materials with multiple colors (simultaneously or sequentially), such as for manufacturing bowling balls. It is contemplated that the present apparatus can be used to mix non-reactive materials as well.

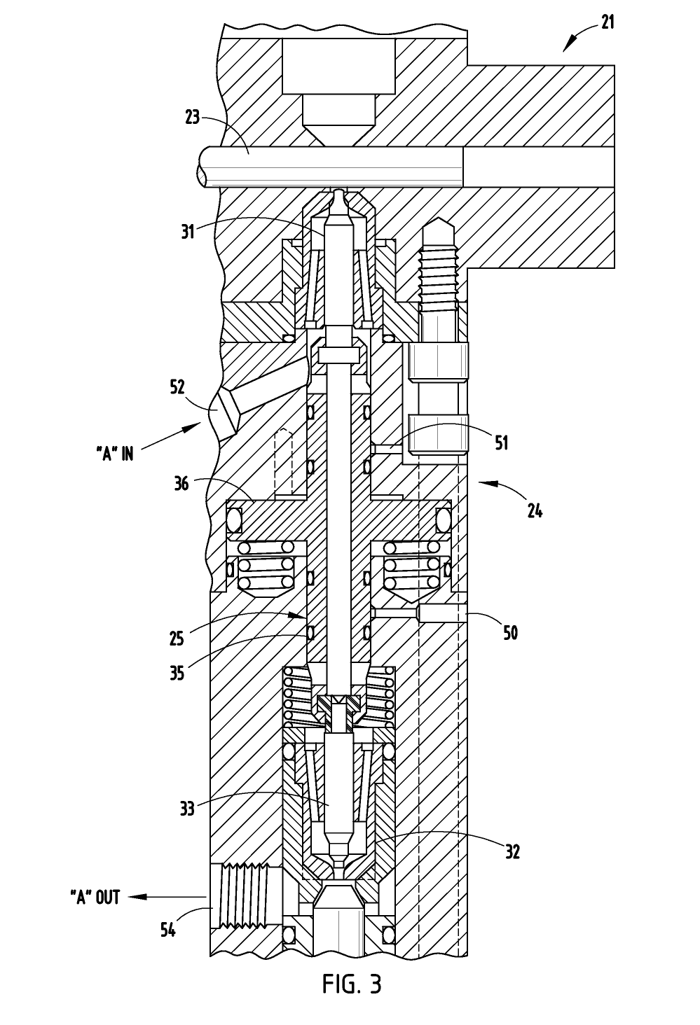

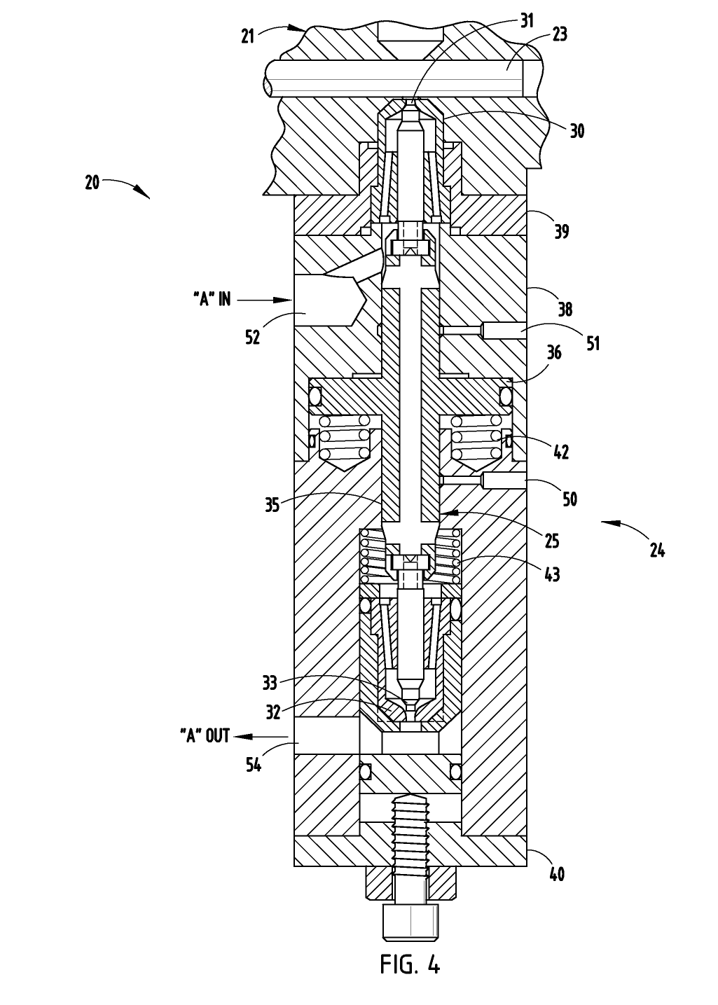

FIG. 3 is an enlarged cross section of one of the preassembled valve assembly in FIG. 1. As can be seen, the hydraulic control valve assembly 24 includes a Bosch orifice 30 at one end forming a pre-calculated opening for material flow into the main mix head 21, with a mating needle 31 for selectively opening and closing the orifice 30. The hydraulic control valve assembly 24 further includes another Bosch orifice 32 (slightly larger) at the other (upstream) end forming a pre-calculated opening for material being recirculated back to the material supply reservoir, and a mating needle 33 for selectively opening and closing the orifice 32. The needles 31 and 33 are connected by a tubular shaft 35 which is fixed to and carries piston member 36. The needle subassembly 25 includes the needles 31 and 33 and also the tubular shaft 35, which form an elongated structure that operates as a unit within the valve assembly 24.

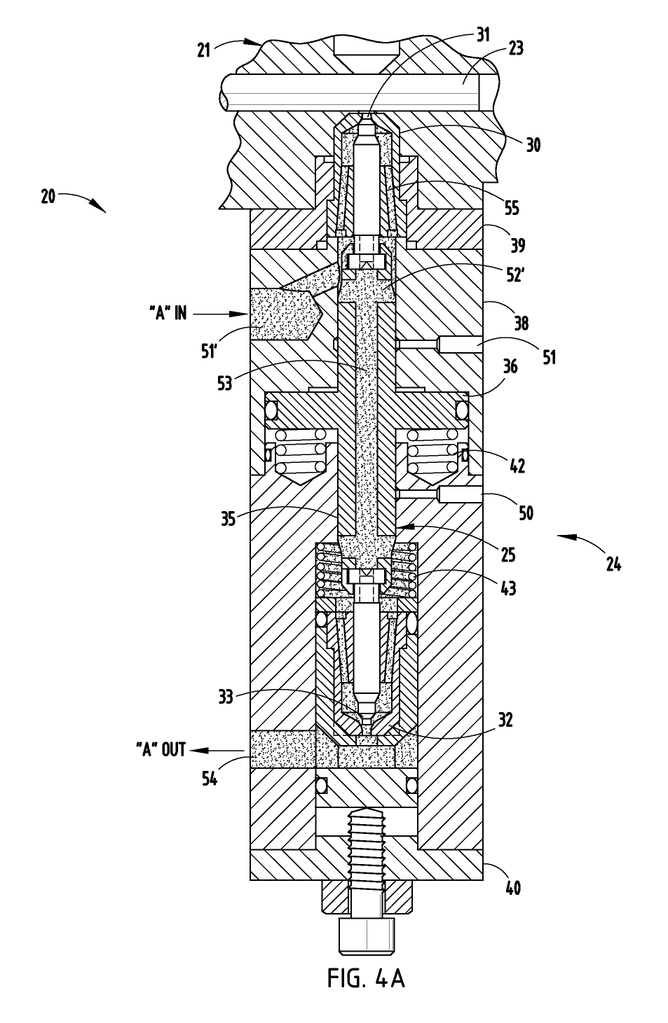

A housing 38 (FIG. 4) extends between end caps 39 and 40 and forms a chamber for piston member 36 to operate. Threaded openings and passageways are formed in the housing 38 for attachment of hydraulic lines such as hydraulic lines 50, heated-fluid lines such as lines 51, and material supply lines such as lines 52. The end cap 39 accurately locates a depth of the orifice 30 and needle 31 relative to the mixing chamber in the main mix head 21. The end cap 40 accurately locates the orifice 32 relative to the needle 33. This allows the needle 31 to accurately seat and close orifice 30 when needle 33 opens the orifice 32, and also allows the needle 33 to accurately seat and close the orifice 32 when the needle 31 opens the orifice 30. Springs 42 operate on the needle subassembly 25 to facilitate proper function, as will be understood by a person skilled in this art. For example, springs 42 bias the system to the closed (recirculation) positions so that, if power is lost, the system maintains separation of materials, which is a best state for re-starting the system.

FIG. 4 is a cross section similar to FIG. 3 with the control needle subassembly 25 being shown in a closed recirculating position (i.e., needle 31 seated and closed in orifice 30, and needle 33 pulled for opening orifice 32). FIG. 4 has a modified adjustment mechanism at the material outlet end for adjustably affecting material flow, and also shows some of the screw fasteners for attaching the preassembled valve assembly 24 to the mix head 21.

FIG. 4A is an identical view to FIG. 4 but with shaded areas showing movement of material A as it recirculates from an input opening through the valve assembly to the return opening. Specifically, when needle 31/orifice 30 is closed and needle 33/orifice 32 is open (see FIG. 4A), the material A flows into a material inlet opening and along passageway 51′ to an annular cavity 52′, and then into and along the passageway 53 within the tubular shaft 35 around the needle 33 to an outlet passageway 54 back to the material supply.

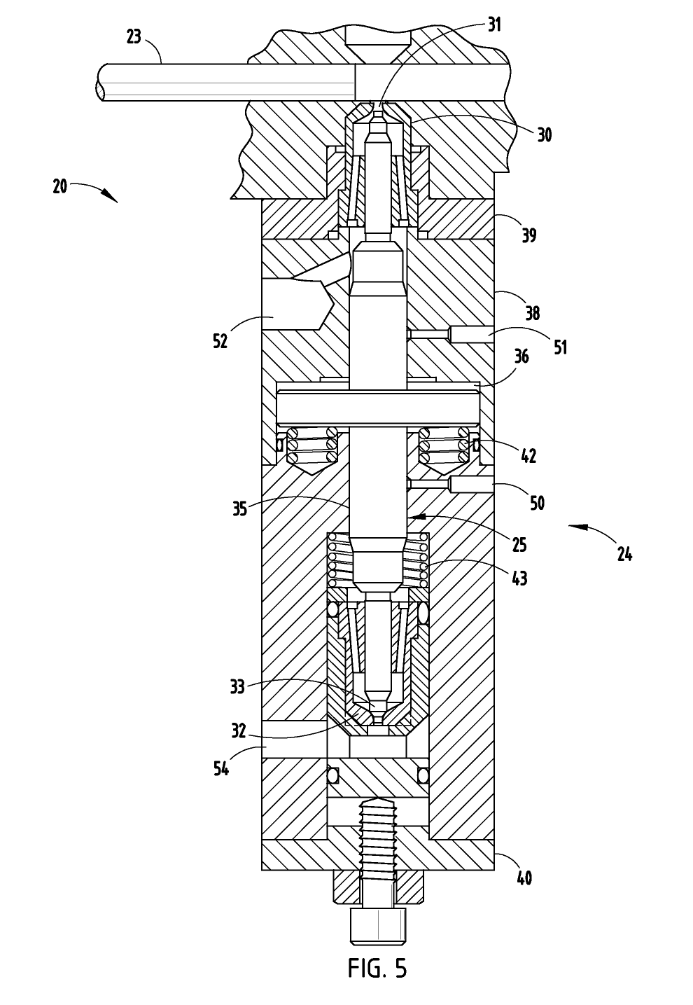

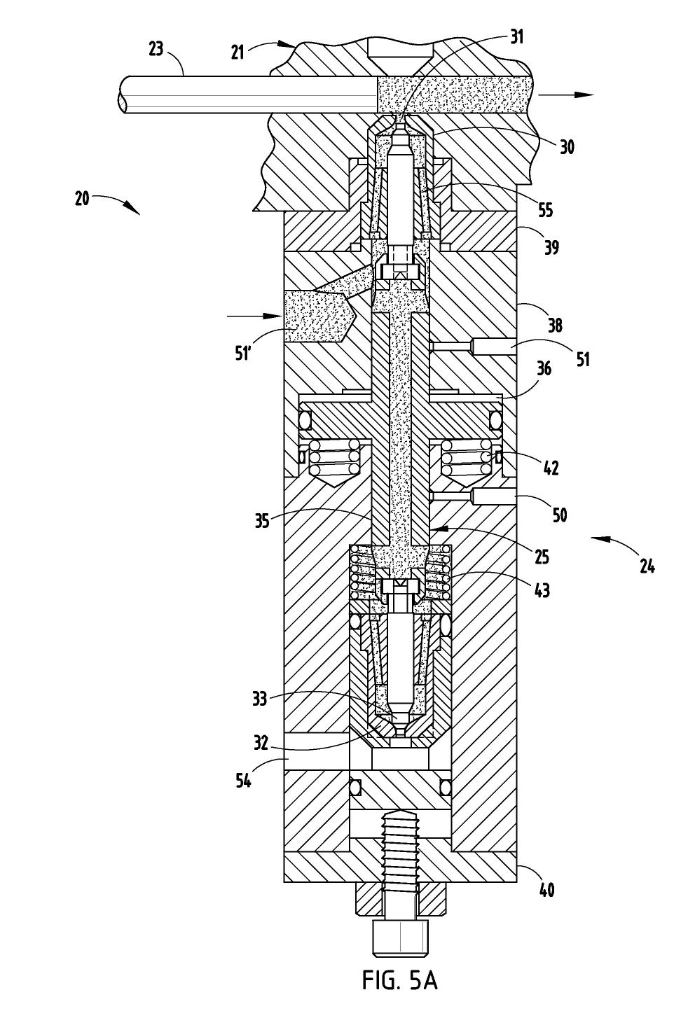

FIG. 5 is a further enlarged cross section of FIG. 3 similar to FIG. 4 but with the control needle subassembly in an open injecting position (i.e., shifted to the right) (i.e., needle 33 seated and closed in orifice 32, and needle 31 pulled for opening orifice 30). FIG. 4A is an identical view but with shaded areas showing movement of material A as the material is injected into a cavity previously occupied by the ejection piston for mixing. When needle 31/orifice 30 is open and needle 33/orifice 32 is closed (see FIG. 5A), the material flows along passageway 51 into injection passageways 55 and through orifice 31 into the mix chamber of the main mix head 21. By this arrangement, the initial start-up parameters and also continuing volume/ratio and pressures can be very accurately and closely controlled.

In one example of operation, the cleanout plunger 23 is pulled first (such as to allow introduction of Nitrogen gas). Thereafter, the needle valve for starting flow of the more viscous material (such as material “A”) is pulled slightly before the needle valve for the more fluid material (such as material “B”). This sequence is timed so that the two materials “A” and “B” enter the mix chamber at the desired ration. Hence, it prevents the material “B” from entering the mix chamber ahead of the more viscous material “A”. The sequence is essentially reverse upon termination of mixing. Thus, this timed arrangement leads to a more accurate mix during the complete mix cycle, including mix initiation, continuance, and termination. Notably, the same principle can be used when there are three or more materials, such as when a third material such as a color, foaming agent, fire retardant, or other third material is added to the mix.

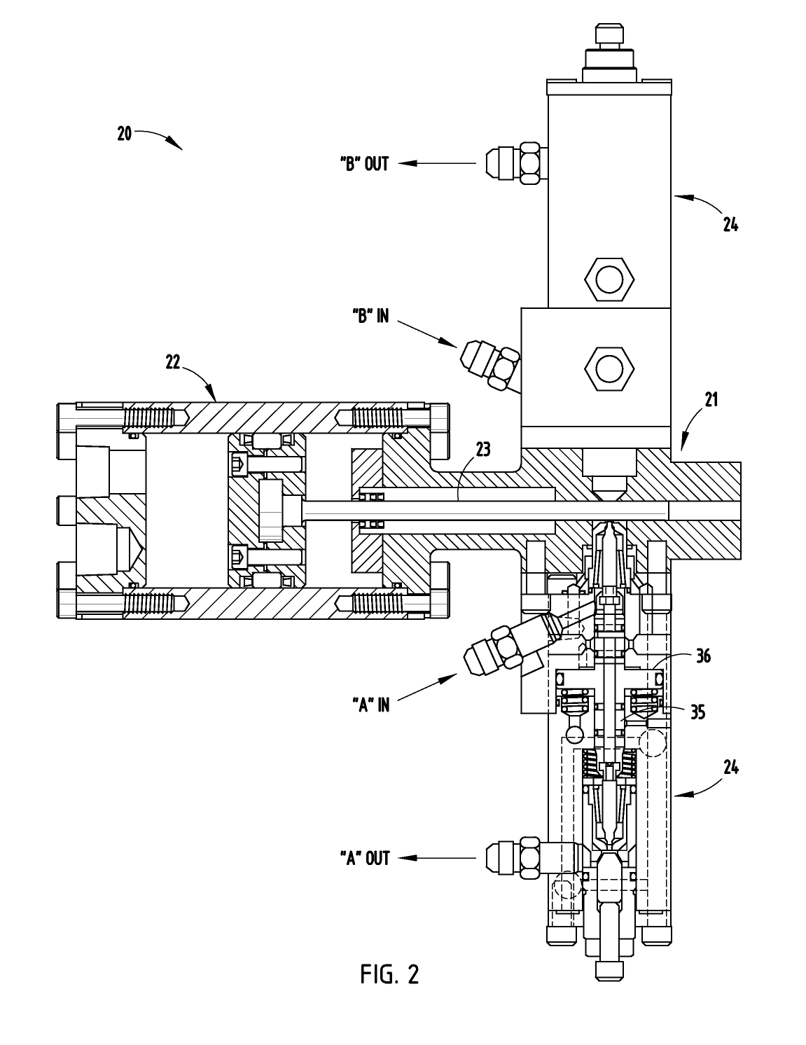

In the present system, the control valve assemblies 24 (including needles 31/33 with orifices 30/32) control flow of material independently, including control of material flowing into the mixing head and also control the material flowing as part of recirculation. In the present system, the ejection piston 23 (also called a “clean-out plunger”) (FIG. 2) controls release of material from the control valve assemblies 24 into the main mixing head 21. Notably, the ejection piston 23 does not include longitudinal grooves that participate in the recirculation system. Instead, both the ejection piston 23 and the mating surface in the bore of the mixing head are cylindrical and smooth, and the piston 23 closely engages the bore to eliminate material bypass. It is noted that the end of the needle 31 when closed is positioned very close to an outer surface of the ejection piston 23. By this arrangement, many problems are reduced or eliminated, such as reduction in cross-contamination of materials A and B, reduction in wear or plugging of the longitudinal grooves and adjacent material of the ejection piston (even when abrasive materials A or B are used), and the like. Further, the present mixing head can be used on materials that do not seal well, which is a material property that assists in material traveling through a longitudinal groove of an ejection piston staying within the groove and not crossing over and cross-contaminating a dissimilar material during recirculation (where the dissimilar material is flowing through an adjacent groove in the ejection piston).

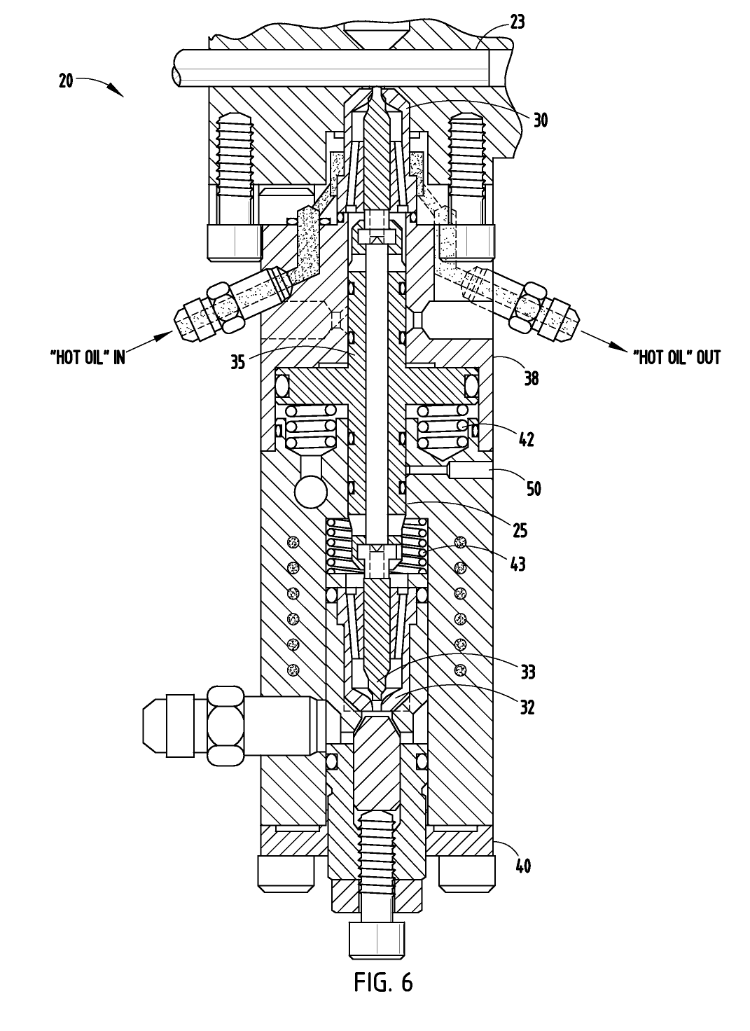

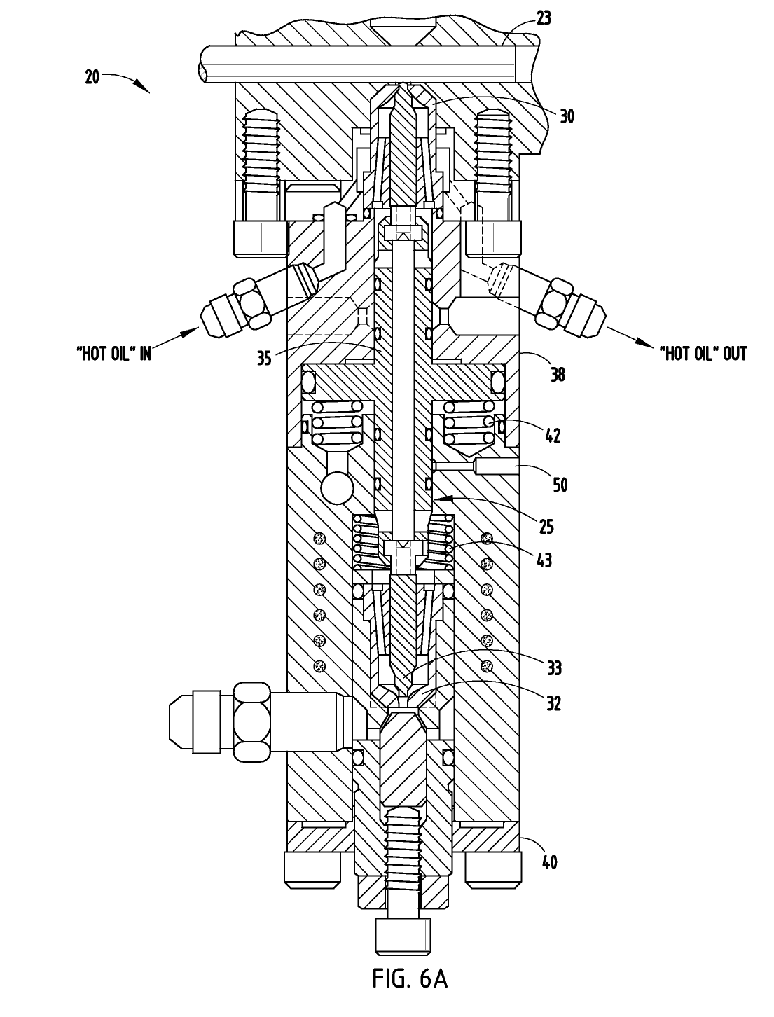

FIG. 6A is a cross section similar to FIG. 4, but showing a heating system 59 for heating an area around the control needle subassembly. FIG. 6A is an identical view but with shaded areas showing flow of heated material around the control needle subassembly. The heating system 59 (see FIG. 6A) includes an inlet 60 for heated fluid (such as heated oil, heated water or steam, or other material), a passageway 61 leading to a heating chamber 62 around and near the orifice 30/needle 31, a sequential passageway 63 leading to a second heating chamber 64 around the injector-side of the tubular shaft of the piston assembly, and to an outlet passageway 65. The heating system 59 also includes a second heating zone including an inlet passageway 66, an annular chamber 67 around a remote end of the tubular shaft of the piston assembly, and to an outlet passageway 68.

Control operation of the present mixing head is by hydraulic power or pneumatic power (such as compressed nitrogen). Each individual valve is independently controlled and timed. The main dispensing nozzle is controlled by hydraulic power and is self-cleaning, eliminating the need for cleaning media and cleaning cycle time. Individual independent adjustments on recirculation pressure and dispense pressure are manually set with optional hydraulic or spring control to maintain uniform pressure control from recirculation to dispense.

Maintaining consistent flow rate and ratio within tight tolerances is dependent on balancing the recirculation and dispense pressures. Pressure fluctuations will cause flow rate and ratio fluctuations due to the metering pump or cylinder bypass, depending on the efficiency ratio of the metering system. The present system provides very accurate individual controls for each material and hence excellent control of ratios and mixing during all phases (i.e. during initiation, continuation, and termination) of injection during a molding cycle. This is because the present system allows close control and maintains pressure balance (and avoids pressure spikes), which greatly assists in maintaining the correct flow and ratio, since pressure fluctuations will cause “breathing” (i.e. expansion or ballooning) of flexible lines which can act as accumulators and prevent consistent flow rate of the metered component. Further, the modular design of the present assembly allows easy replacement of seals and normal wear items. The mixing head is constructed of tool steel and stainless steel on wetted chemical parts for optimal performance.

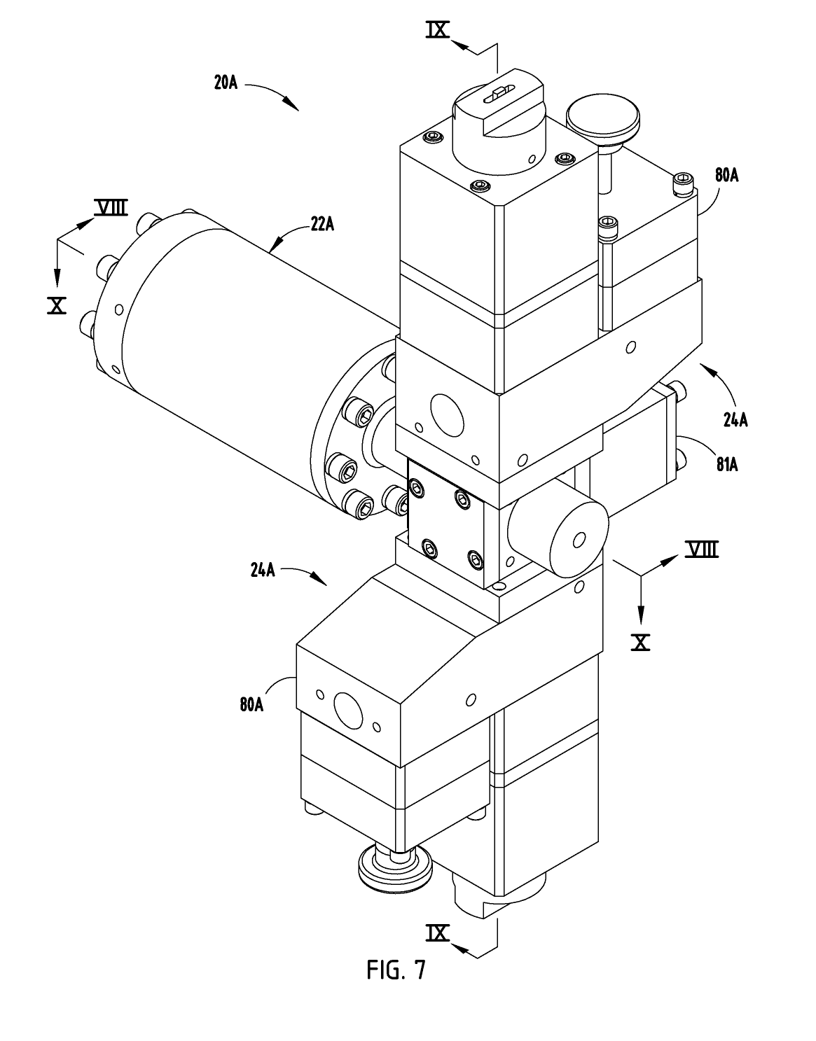

A modified mixing head assembly 20A is shown in FIG. 7 that is similar to FIG. 1. Similar numbers are used to identify identical and similar components, features, and aspects, with the addition of the letter “A”. This is done to reduce redundant discussion. Notably, the illustrated mixing head assembly 20A does not include heaters, but heaters could be added such as by drilling hot-oil-passages into the blocks, or by adding external band heaters or rod heaters. Also, the illustrated assembly 20A only includes two pneumatic control valve assemblies 24A, but it is contemplated that up to eight or more such subassemblies 24A could be positioned around the mixing head. The subassemblies 24A differ from subassemblies 24 in that each subassembly 24A includes a non-tubular solid shaft 35A and a pressure relief valve 80A. Also, assembly 20A includes a compressed Nitrogen purge valve 81A in one of the stations on the mix head, where Nitrogen can be injected into the mix head and mold cavity to purge oxygen from the system prior to mixing of materials and inflow into the mold.

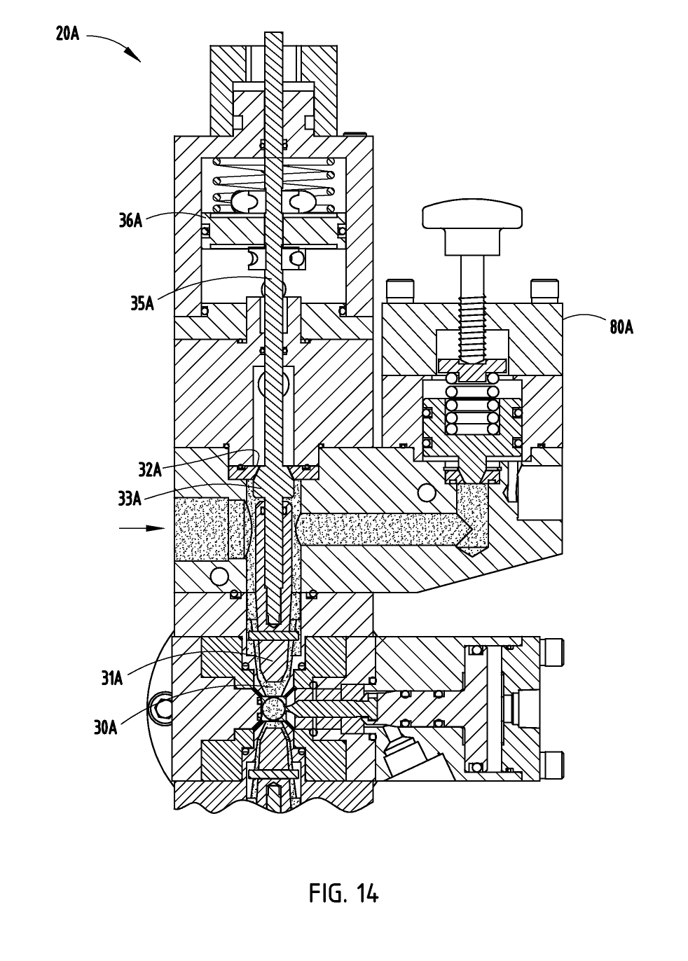

Specifically, FIGS. 14-16 show an enlarged cross section of one of the preassembled valve assemblies 24A. As can be seen, the control valve assembly 24A includes an orifice 30A and a mating needle 31A for selectively opening and closing the orifice 30A. The control valve assembly 24A further includes another orifice 32A (slightly larger) at the other end forming an opening for material being recirculated back to the material supply reservoir, and a mating needle 33A for selectively opening and closing the orifice 32A. The needles 31A and 33A are connected by or formed integrally on a non-tubular solid shaft 35A (made of two telescopingly interconnected shaft components) which is fixed to and carries piston member 36A. The needle subassembly 25A includes the needles 31A and 33A and also the shaft 35A, which form an elongated structure that operates as a unit within the valve assembly 24A.

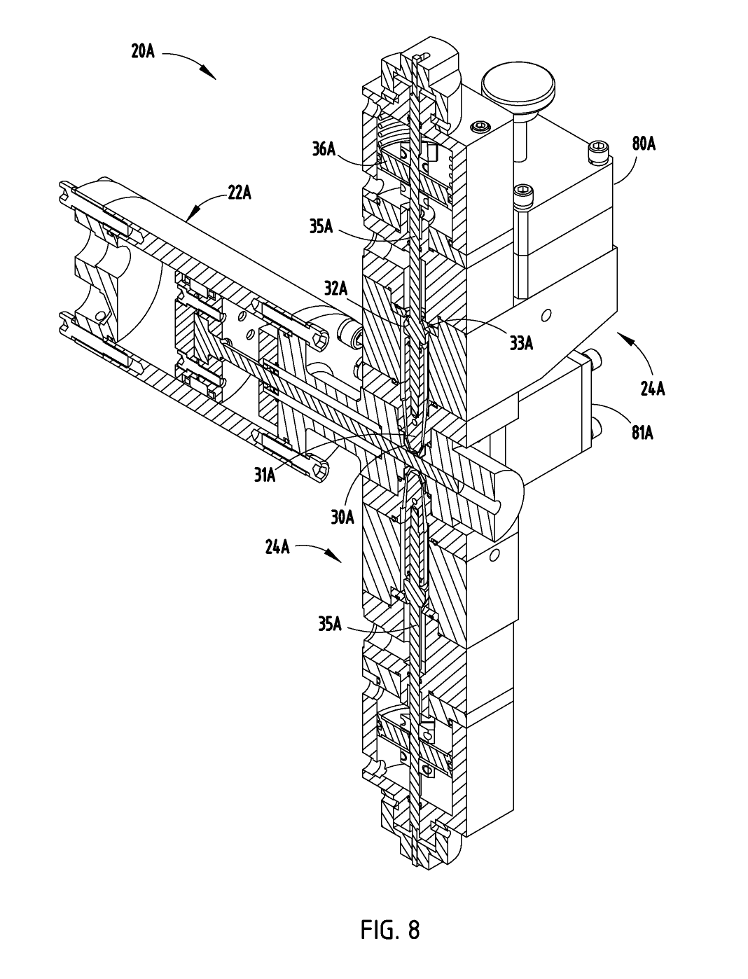

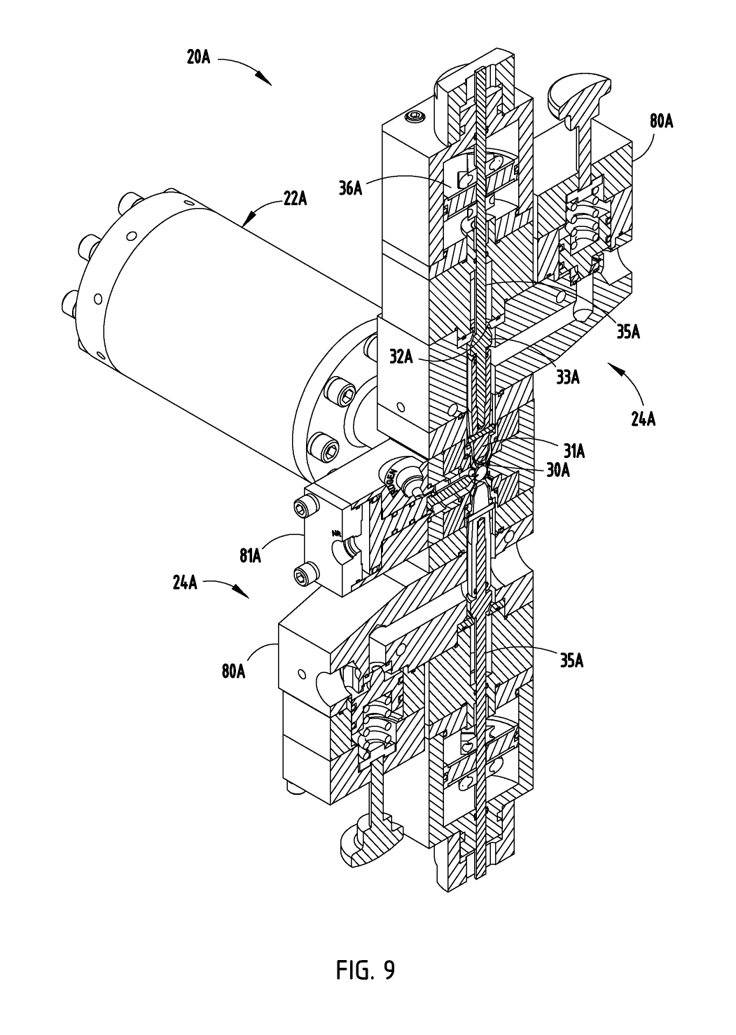

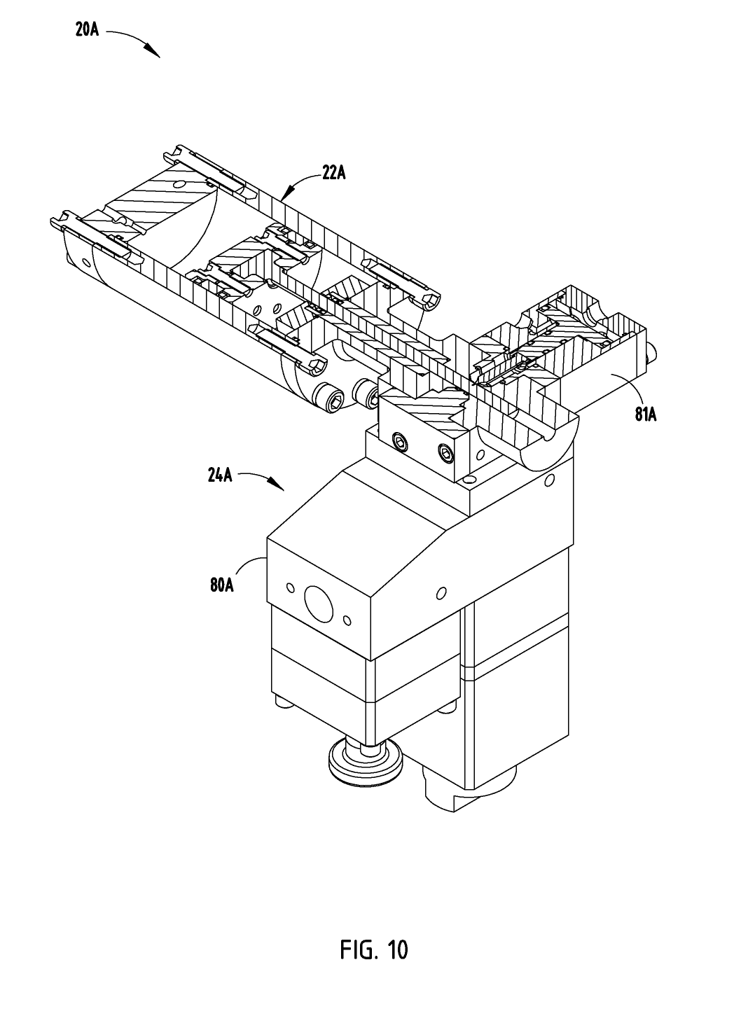

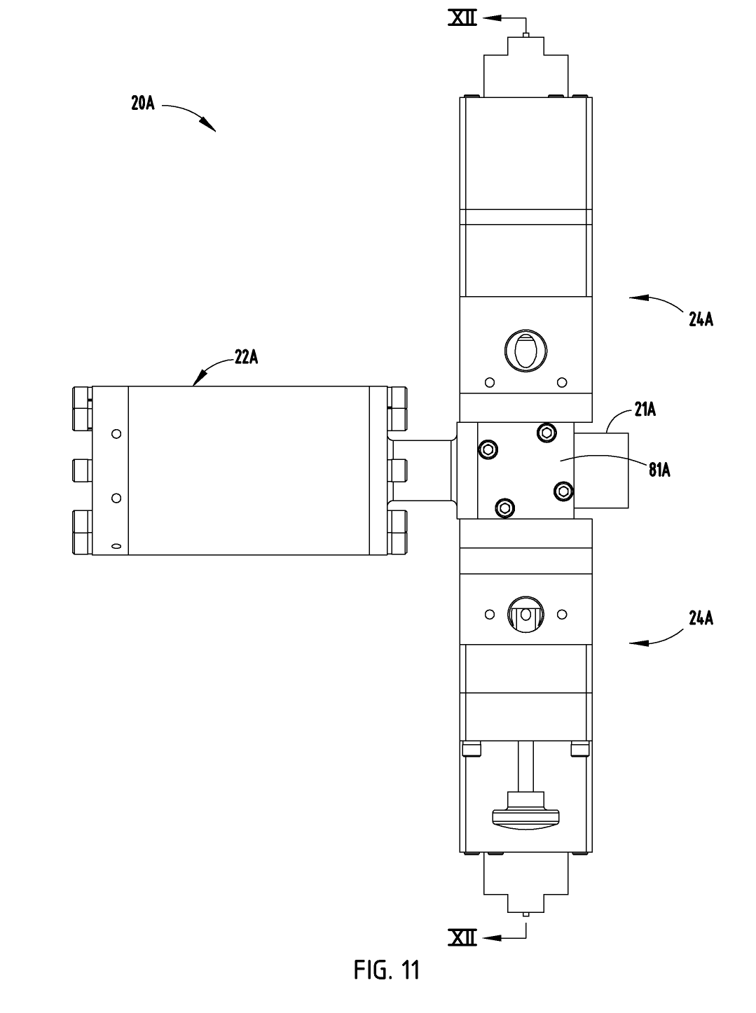

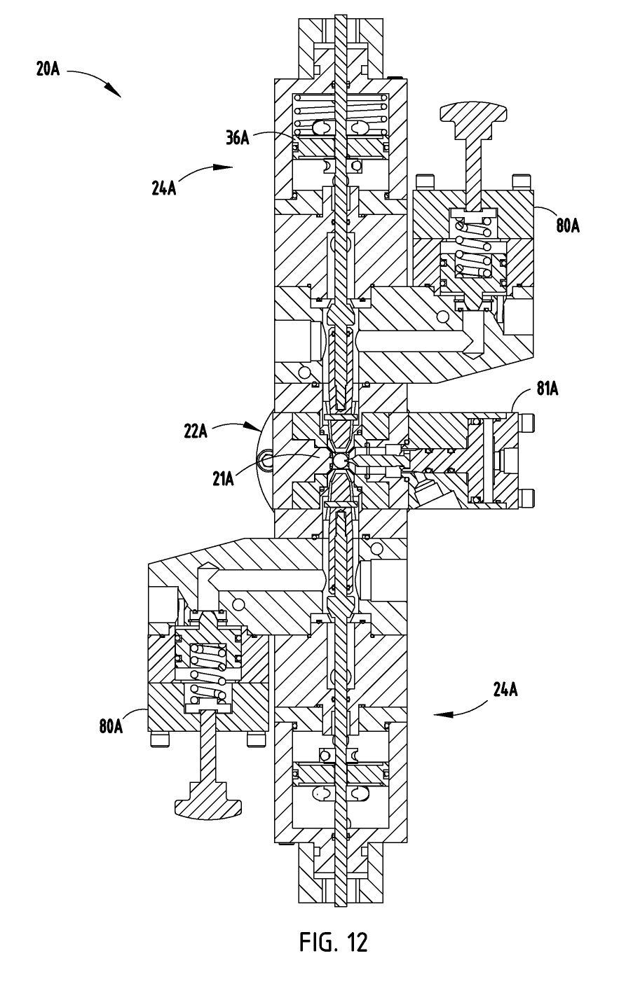

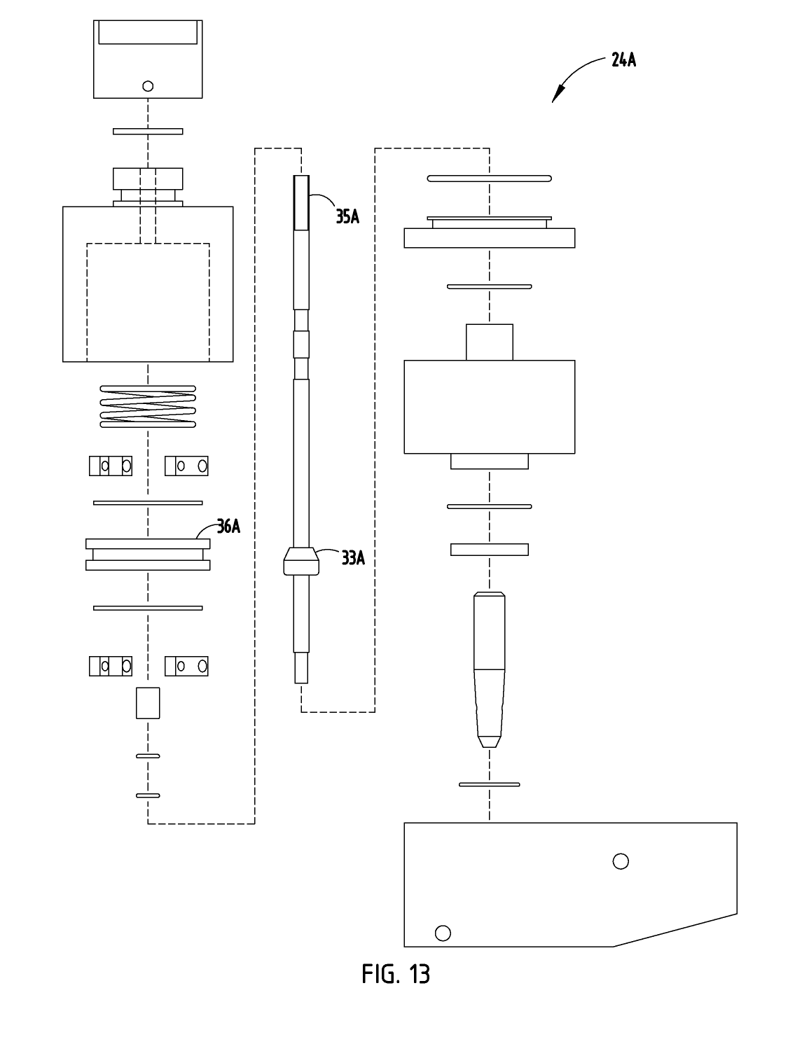

FIGS. 8-10 are cross sectional (perspective) views taken through FIG. 7 along orthogonal planes, and illustrate various components using similar numbers as FIGS. 1-6 but with the addition of the letter “A” as noted above. FIG. 11 is a cross sectional plan view similar to FIG. 2, and FIG. 12 is a cross sectional view along line XII-XII in FIG. 11. FIG. 13 is a partially exploded view of portions of FIG. 12.

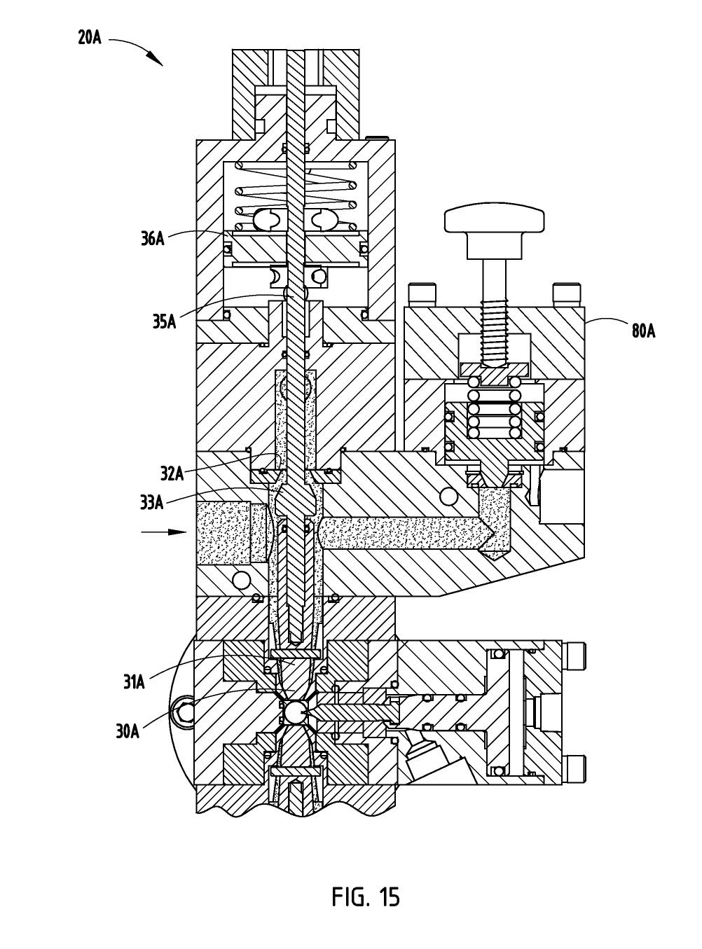

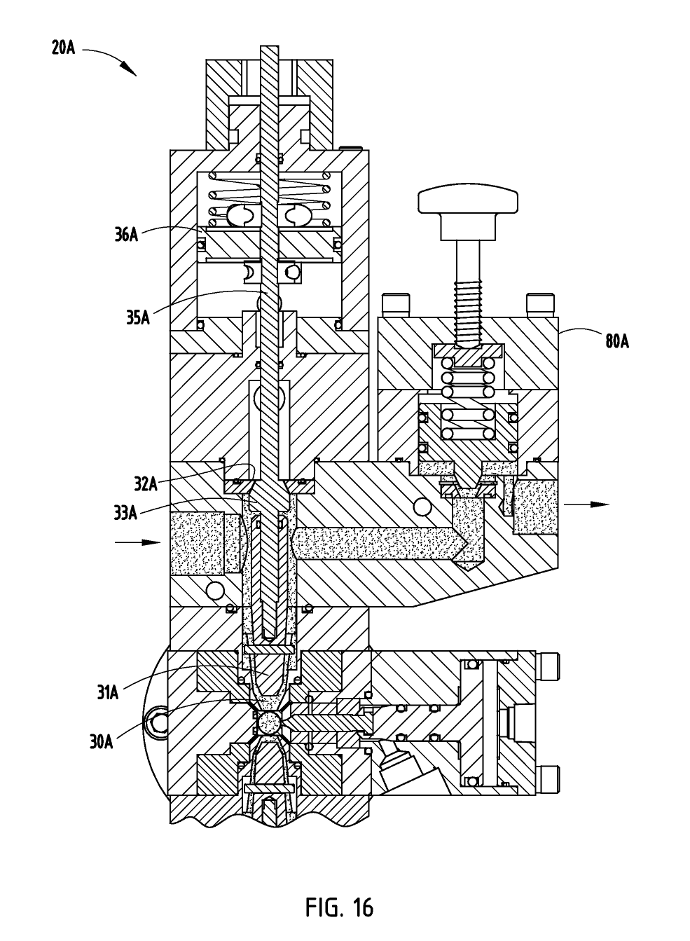

FIG. 14 is a fragmentary view of half of FIG. 12, with components in their material-recirculation positions, and FIG. 15 is a fragmentary view similar to FIG. 14, but with components in their material-injection positions. FIG. 16 is a view similar to FIG. 14 but showing components in flowing to a relief valve to eliminate overpressures and/or pressure spikes. If desired, the valve 80A can act as a dampener to minimize pressure spikes, which are detrimental to uniform fluid flow during operation of the injector head.

It is contemplated that the present assembly can be operated in different sequences. As an example of one setup/operation, when the injection cycle is begun, the cleanout plunger 23A is pulled and compressed Nitrogen is fed by valve 81A into the mix chamber and mold cavity to clear oxygen from same. Then, the needle valve(s) 31A open and simultaneously the needle valve(s) 33A of each subassembly 24A close in a timed sequence relative to each other and to the cleanout plunger 23A so that the materials A and B impinge each other in the mix chamber in proper ratio from initiation through continuous mixing to the termination phase. At the termination phase, the needle valve(s) 31A close (shutting off flow to the mix chamber) and the needle valve(s) 33A of each subassembly 24A open to re-establish re-circulating flow of materials A and B. (See FIG. 15.) Notably, the purge valve 81A can instead be connected to a supply of color additive, or a foaming agent, or another subassembly 24A.

It is to be understood that variations and modifications can be made on the aforementioned structure without departing from the concepts of the present invention, and further it is to be understood that such concepts are intended to be covered by the following claims unless these claims by their language expressly state otherwise.

The embodiments of the invention in which an exclusive property or privilege is claimed are defined as follows:

1. A mixing head assembly comprising:
a main mix head with a control and ejection piston assembly; and
at least two control valve assemblies each with a controlled needle subassembly having at least one needle valve for controlled feeding of different materials to a mixing chamber of the mix head in predetermined ratios and controlled quantities and at high pressures, the ejection piston assembly having a cylindrical surface with no longitudinal channels or grooves for conveying the different materials, and the cylindrical surface closely engaging a mating surface on the main mix head.

2. The assembly defined in claim 1, wherein the at least two needle valve assemblies include a body defining a first longitudinal passage extending in a first direction toward a mixed material outlet and a second longitudinal passage extending in an opposite direction toward a return line.

3. The assembly defined in claim 1, wherein the at least two control valve assemblies include at least four control valve assemblies.

4. The assembly defined in claim 1, wherein the at least one needle valve includes a needle valve at each end of valve assembly.

5. The assembly defined in claim 1, including a heating system for heating the needle subassembly to a constant elevated temperature.

6. The assembly defined in claim 5, wherein the heating system includes two separate heating zones in each of the two needle valve assemblies.

7. The assembly defined in claim 1, wherein the valve assemblies include a body and a solid rod therein, the rod including at least one of the needle valves.

8. The assembly defined in claim 1, wherein the valve assemblies include a body and a tubular rod therein, the rod defining at least a portion of a passageway for an associated one of the different materials.

9. A mixing head assembly comprising:
a main mix head with a control and ejection piston assembly; and
at least two control valve assemblies each with a controlled needle subassembly having a needle valve at each end for controlled feeding of different materials to a mixing chamber of the mix head in predetermined ratios and controlled quantities and at high pressures.

10. The assembly defined in claim 9, including a heating system for heating the needle subassembly to a constant elevated temperature.

11. The assembly defined in claim 9, wherein the ejection piston assembly has a cylindrical surface with no longitudinal channels or grooves for channeling mix material, the cylindrical surface closely engaging a mating surface on the main mix head.

12. A mixing head assembly comprising:
a main mix head with a control and ejection piston assembly; and
at least three control valve assemblies each with a controlled needle subassembly for controlled feeding of different materials to a mixing chamber of the mix head in predetermined ratios and controlled quantities and at high pressures.

13. A method of mixing materials comprising steps of:
providing a main mix head with a control and ejection piston assembly; and
providing at least two control valve assemblies each with a controlled needle subassembly having a needle valve immediately adjacent the main mix head, the ejection piston assembly having a cylindrical surface with no longitudinal channels or grooves, and the cylindrical surface closely engaging a mating surface on the main mix head; and
simultaneously controlling the feeding of different materials to a mixing chamber of the mix head in predetermined ratios and controlled quantities and at high pressures.

14. A method of mixing materials comprising steps of:
providing a main mix head with a control and ejection piston assembly; and
providing at least two control valve assemblies each with a controlled needle subassembly having a needle valve at each end; and
simultaneously controlling the needle valve at each end for controlled feeding of different materials to a mixing chamber of the mix head in predetermined ratios and controlled quantities and at high pressures.

15. A mixing head assembly comprising:
providing a main mix head with a control and ejection piston assembly;
providing at least three control valve assemblies each with a controlled needle subassembly; and
simultaneously operating the at least three valve assemblies to control feeding of different materials to a mixing chamber of the mix head in predetermined ratios and controlled quantities and at high pressures.
